(19) United States
(12) Patent Application Publication
(10) Pub. No.: US 2008/0091804 A1
(43) Pub. Date: Apr. 17, 2008

(54) Media delivery utilizing intelligent group list management

(75) Inventors: Scott Allen Swanburg, Duluth, GA (US); Chris Allen Young, Roswell, GA (US); Andre Gen Okada, Seattle, WA (US)

Correspondence Address: MOAZZAM & ASSOCIATES, LLC;MATTERS FOR CINGULAR WIRELESS II, LLC, 7601 LEWINSVILLE ROAD, SUITE 304, MCLEAN, VA, 22102, US

(73) Assignee: Cingular Wireless II, LLC

(21) Appl. No.: 11/545,592

(22) Filed: Oct. 11, 2006

(51) Int. Cl. G06F 15/173

(52) U.S. Cl. 709/223

(57) ABSTRACT

A system for delivering content from one user to a plurality of other users across a network is disclosed. A user transmits content and a list of users to a network server. The network server determines what devices each target user is presently operating. The network server may convert the content into a format compatible with a target user's device. The network server then transmits the formatted content to each target user.

### BACKGROUND OF THE INVENTION

1. Field of the Invention

The present invention relates to content delivery. More particularly, the present invention relates to content delivery from one user to one or more users in one or more networks.

2. Background of the Invention

The advent of the electronic era has brought people closer together in many ways. Thanks to mobile technology, people can remain in touch regardless of where they are. A group of friends can use mobile technology to quickly plan and arrange a night out the afternoon before. Someone who is lost or needs direction can easily communicate with others to find her way. Parents can use mobile telephones to keep tabs on their children. If an afternoon activity is cancelled or the school day shortened due to inclement weather, a child can place a call to her parents and make alternate arrangements so that the child is not stuck at school.

Mobile technology has provided other ways for people to interact with one another. Users may send short text messages to keep their friends and family informed of events without tying up a phone line. Many mobile phones now come equipped with cameras so that users can take a snapshot of an important landmark or amusing scene and forward copies to friends and family.

However, several obstacles remain for the goal of complete interaction, especially in the area of content delivery. Devices may use incompatible formats. If two friends, Joe and Rachel, use two incompatible devices, Joe cannot send content to Rachel because Rachel's device cannot read it. Joe must first convert the content to a compatible format before sending the content to Rachel. Converting the content to a different format may not be simple, and may require tools that Joe does not have. Even if Joe and Rachel have compatible devices, Joe may not be able to determine if Rachel is available to receive content. Many current devices have no way for users to determine if others are available to receive content.

For example, a new father, whose daughter just took her first steps, wants to send a video of the important milestone to his sister, his brother, and his parents. Such a task is difficult using present technology. The sister may be using her mobile phone at the time, while his brother may be watching television using an internet protocol entertainment device, such as a digital video recorder. His parents may be currently accessing the Internet through their personal computer. However, the father has no way of knowing this without asking each relative first. Once the father figures out where his family members are, he can send the video to them. However, each family member must receive the video in a different format, since each family member is using a different device. The father could send a low-resolution video capable of being received by his sister's mobile phone to each of his family members, but then his brother and his parents would suffer from a sub-standard experience. The devices his brother and parents are using are capable of playing the video back at a higher quality than his sister's mobile phone. If the father wants to take advantage of the higher quality, he would have to first convert the video into three separate formats, one for his sister, one for his brother, and one for his parents. Once he does this, the father must send the content, one at a time, to each of his family members. As a result, what should be a simple procedure, sending a video of his daughter's first steps to family members, has become a laborious and time-consuming task.

What is needed is a way for a user to send content to other users without having to figure out how to send the content or the optimum way to deliver the content.

### SUMMARY OF THE INVENTION

The present systems and methods for delivering content from one user's device to other users' devices are inconvenient and inefficient. The user must first determine what devices the others are using. Then the user must convert the content into a format that the others' devices can read, which may result in multiple translations if each user has a different device. To address these and similar shortcomings of conventional techniques, the present invention eliminates the need for the user to know how to send the content to other users. From the user's perspective, the system “just works”.

In one exemplary embodiment, the present invention is a system for delivering content from a user to a plurality of other users. The system includes a plurality of components. A networks contact list component stores a list of users and corresponding information about each user. The information may comprise location information, presence information, device information, or availability information. A reception component is capable of receiving a transmission from a first device. The transmission comprises content and a set of users to whom the content should be delivered. A transmission component is capable of transmitting the content to each of the other users based on said information stored in the contact list component.

In another exemplary embodiment, the present invention is a system for updating a network contact list. A contact list component stores a list of users and corresponding information about each user. The information may comprise current location, current presence, current device, or current availability. An update component is capable of receiving updated information and updating the network contact list component with the updated information. An update transmission component is capable of transmitting updated information to the update component.

### BRIEF DESCRIPTION OF THE DRAWINGS

FIG. 1 shows a view of a user transmitting content to a plurality of users through a network server according to the present invention.

FIG. 2 shows components of a network server according to an exemplary embodiment of the present invention working to seamlessly transmit content from one user to a plurality of users.

FIG. 3 shows components of a network server updating a network contact list according to another embodiment of the present invention.

FIG. 4 shows a method of updating a network contact list according to an exemplary embodiment of the present invention.

FIG. 5 shows a method of seamlessly transmitting content from use user to a plurality of other users according to an exemplary embodiment of the present invention.

### DETAILED DESCRIPTION OF THE INVENTION

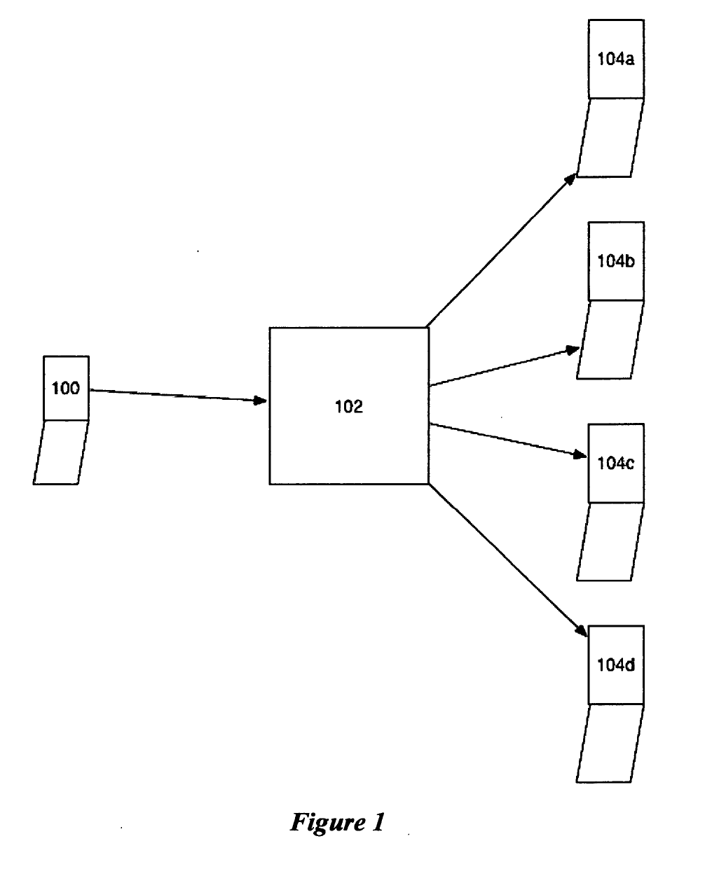

The present invention provides for a system to seamlessly send media/content from one user to a plurality of other users based on an intelligent collection of information such as presence, availability and location. This information is gathered as a means to provide a best path of communications to multiple users. The system delivers media to one or more recipients based on this intelligence and is dynamically updated in order to constantly provide this intelligent path. An overview of the present invention is shown in FIG. 1. User 100 transmits media to users 104a, 104b, 104c, and 104d through network server 102. When network server 102 receives the media from user 100, network server 102 gathers information from a variety of sources regarding pertinent information about the recipients such as presence, availability and location and creates a path of communication using this intelligence. This intelligence available in the network determines what devices are being operated by users 104a, 104b, 104c, and 104d and the best method to communicate to them. Server 102 then transmits the media to the particular device that each user 104a, 104b, 104c, and 104d is using. If necessary, network server 102 may convert the video stream into different formats optimized for each device currently operated by users 104a, 104b, 104c, and 104d. In this fashion, each user receives media optimized for his particular device without the user 100 needing to figure out what device each user 104a, 104b, 104c, and 104d is presently operating or what format the media should be sent in and which device/path is best to send the media to. From user 100's perspective, the system “just works.”

The present invention may be operated in a variety of contexts and environments. Users 100, 104a, 104b, 104c, and 104d could operate on the same network or on different networks. Users 100, 104a, 104b, 104c, and 104d could operate any type of device, such as a mobile device (including mobile telephones and personal digital assistants), a personal computer, or an internet protocol enabled entertainment device. The devices could communicate with one another and with a network using any convenient protocol. User 100 could transmit any content users 104a, 104b, 104c, and 104d. The content could include data, music, video, photographs, or real-time streaming video (or audio).

For example, user 100 could wish to send streaming video to users 104a, 104b, 104c, and 104d. User 100 selects the other users to whom he wishes to send the streaming video (in this example, users 104a, 104b, 104c, and 104d) and transmits the video. Server 102 receives the request and determines what devices the users 104a, 104b, 104c, and 104d are presently using. Server 102 determines that user 104 is using a mobile device, users 104b and 104c are using personal computers, and user 104d is using an internet protocol enabled digital entertainment device (such as a digital video recorder). Server 102 then transmits the video to user 102's mobile device, to the personal computers being used by users 104b and 104c, and to user 104d's internet protocol enabled digital entertainment device. This may require streaming the video in a different format. Thus, server 102 could transmit a low-resolution stream to user 104a suitable for reception by a mobile device. User 104b, in contrast, could receive a high-definition video stream, since he is using a personal computer capable of displaying a high-definition video stream.

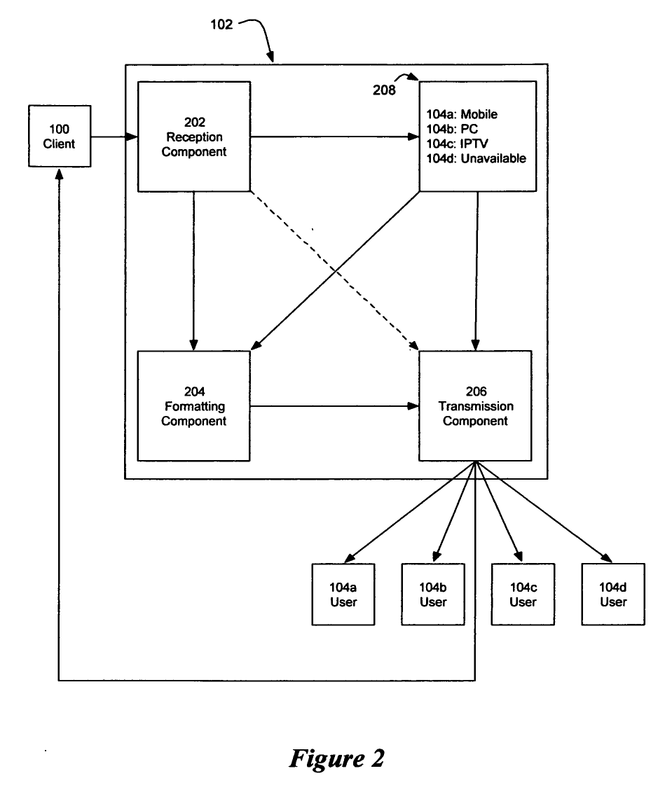

FIG. 2 shows a first exemplary embodiment of the present invention in the form of server 102. Server 102 includes a number of components. Reception component 202 receives transmissions from users such as user 100. These transmissions include content and the identities of the users to whom the content should be delivered. A network contact list component 208 stores the names of users and information about each user. A formatting component 204 receives the content and the identities of users to whom it should be delivered and obtains corresponding information about the users from network contact list component 208. Using the information from network contact list component 208, formatting component 204 determines, for each user to whom the content is to be delivered, the format in which the content should be delivered. Formatting component 204 then converts the content into separately formatted content optimized for the particular device users 104a, 104b, 104c, and 104d are operating. For example, if user 104a is using a mobile device, formatting component 204 will convert the content into a format suitable for reception by a mobile device. Once formatting component 204 has converted the content into formatted content, transmission component 206 then delivers the formatted content to the users 104a, 104b, 104c, and 104d. Note that users 104a, 104b, 104c, and 104d will each receive differently formatted content for the particular device each user is operating. For example, user 104a, who is operating a mobile device, may receive content formatted for a mobile device, while user 104b, who is operating a personal computer, will receive content formatted for a personal computer. In addition, transmission component 206 may use the information in network contact list component 208 to determine the optimal way to transmit the content to each user 104a, 104b, 104c, and 104d. For example, if user 104a is on a wireless network, transmission component 206 may transmit the content using a wireless protocol. If user 104b is on a data network (such as the Internet), transmission component may transmit the content using TCP/IP.

Network contact list component 208 stores the identities of each user and information about each user. The identity could be in the form of a telephone number, MSISDN, or other unique identifier. This information may include a user's location, presence, availability, time of day, and calendar information (the user's schedule). Location information could refer to the city, state, or country the user is presently in; or it could refer to whether the user is at home, work, or school. Presence information could refer to the user's presence on a network and which network the user is in. Availability may refer to whether the user is or is not available to receive content. Device information may refer to the device the user is presently operating.

Any other information about users may also be included. For example, network contact list component 208 could comprise the contact list for user 100; in that case, network contact list component 208 could also include information such as a user's address and telephone number. If network contact list component 208 also serves as user 100's contact list, this would permit the contact list to be accessible to user 100 wherever he is on the network. Network contact list component 208 would comprise a plurality of smaller contact lists for each user on the network. However, contact list component 208 may store any type of information about a user in any convenient fashion known in the art.

Network contact list 208 may communicate with user 100 via reception component 202 and transmission component 206 to provide the user 100 with information about users 104a, 104b, 104c, 104d, thus increasing the intelligence of the network. This communication could be based on information about user 100 stored in network contact list component 208. For example, user 100 might have an 8:00 AM meeting. However, due to poor traffic conditions, the user is not able to attend the meeting on time. The user communicates with reception component 202, which in turn communicates with network contact list 206. Network contact list 208 retrieves information about the other attendees and returns information about the attendees to user 100 via transmission component 202. Network contact list is able to retrieve the correct information about the attendees by consulting information about the user 100b and the world, such as the user's calendar information (meeting at 8:00 AM) and the present time of day (such as 7:15 AM.) As the user enters the message informing the other attendees about his situation, the network can use the information stored in network contact list component 208 to prompt the user 100 with potential addressees (the other attendees) and their availability. The user 100 perceives this as the network having greater intelligence.

In a second exemplary embodiment, shown by the dotted arrow in FIG. 2, the reception component 202 communicates directly with transmission component 206, bypassing formatting component 204. In this embodiment, formatting component 204 is not present or is not used. This embodiment may be used in situations where no formatting of content is required. This may occur when all of the devices on the network use a compatible format to view content, or if none of the users to whom user 100 wishes to send content operate devices that require converting the content to a different format. In this embodiment, reception component 202 may obtain device information from network contact list component 208 prior to communicating with formatting component 204. If reception component 202 determines that no conversion of content is required for a particular user (possibly because that user is operating a device compatible with user 100), reception component may deliver the content directly to transmission component 206 for delivery.

FIG. 2 shows reception component 202, formatting component 204, transmission component 206, and network component 208 as part of one network server 102. However, the components may be arranged in any configuration across any number of network servers. For example, network contact list component 208 could be stored on a first network server, formatting component 204 could be stored on a second network server, and reception and transmission components 202 and 206 could be stored on a third network server.

Multiple components could also be stored on multiple servers in a distributed network to reduce the load on individual servers.

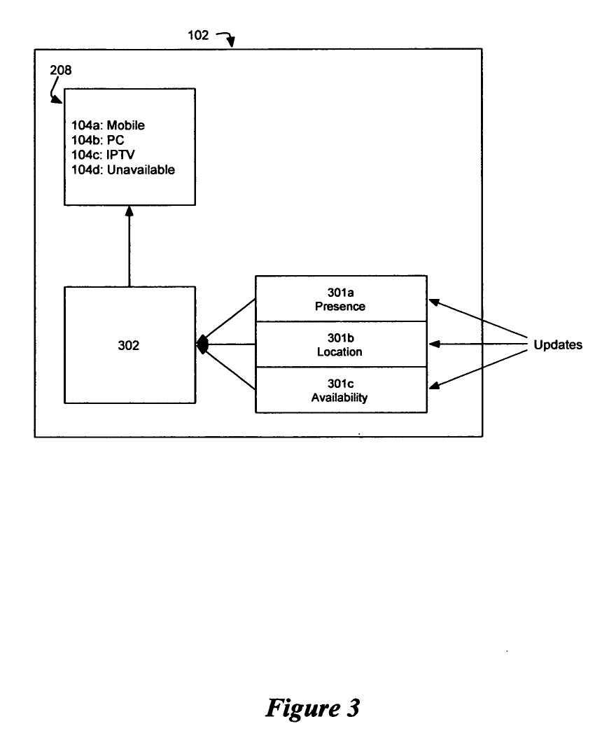

FIG. 3 shows another aspect of the present invention. In order to determine the best method of transmitting content from user 100 to users 104a, 104b, 104c, and 104d, server 102 needs to have updated information about each user 104a, 104b, 104c, and 104d. If server 102 does not have updated information about the users, the content will not be delivered to users 104a, 104b, 104c, and 104d properly.

To this end, server 102 contains update component 302 in addition to network contact list component 208. For the sake of simplicity, FIG. 3 does not show any other components, such as reception component 202, formatting component 204, or transmission component 206. However, these components may also be present in server 102.

Update component 302 receives updated information from users 104a, 104b, 104c, and 104d. The updated information could be any information stored in network contact list component 208. FIG. 3 shows three examples of information update component may receive from users 104a, 104b, 104c, 104d: presence information, location information, or availability information. Presence information relates to the devices known to be capable of receiving media, as well as the type (format) of media those devices are capable of receiving. Availability information includes the devices known to be active or which the user is known to have access to. Location information refers to the location of the user and the location of the user's devices. The components of server 102 can also derive one or more of this information from other information received from the users. The updated information may also include other types of information, such as the time of day or calendar information referring to a user's schedule. Upon receiving updated information from users 104a, 104b, 104c, or 104d, update component 302 updates the corresponding information in network contact list component 208.

Update component 302 may receive updated information from users 104a, 104b, 104c, and 104d in a variety of ways. Update component 302 could receive updated information whenever a user 104a begins to use a particular device or ceases operation of a device. Thus, if user 104a begins using a mobile device, the mobile device transmits updated information informing update component 302 that user 104a is now using his mobile device. Similarly, once user 104a turns his mobile device off or the device becomes idle, the mobile device transmits updated information to update component 302 informing the update component that the user has stopped using the mobile device. If update component 302 has not received information that user 104a has begun using another device, update component 302 could conclude that user 104a is unavailable and can update network contact list component 208 accordingly.

In another variation, update component 302 could receive updated information on a fixed schedule. Devices could transmit updated information to update component 302 every ten or fifteen minutes, or on any other schedule. Users 104a, 104b, 104c, and 104d could also transmit updated information manually. A user 104b could, for example, enter a command into her current device informing the device that she is away and not available to receive content. The device transmits this updated information to update component 302. Update component 302 then updates network contact list component 208 with the information that user 104b is away and not available to receive content. These techniques, other techniques, or a combination of techniques known in the art could be used to transmit updated information to update component 302.

As shown in FIG. 3, update component 302 and network contact list component 208 are separate components. However, these components may also comprise sub-components of one larger component. Similarly, FIG. 3 shows update component 302 and network contact list component 208 as included within one network server. The components may also be spread across multiple network servers. Any configuration is possible depending on the particular network in which the present invention is deployed.

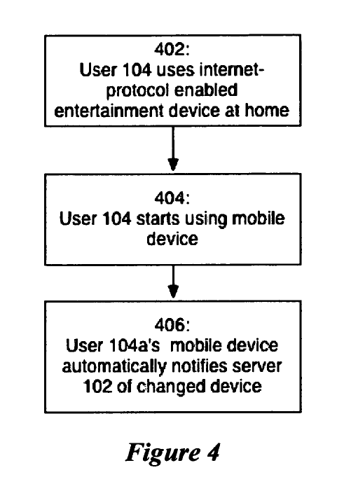

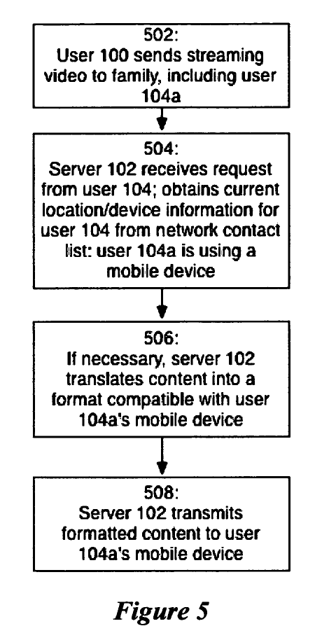

FIGS. 4 and 5 show examples of how the present invention operates. FIG. 4 shows an example of updating information on the network server 102. In step 402, user 104 is using an internet-protocol enabled entertainment device at home. This could be an “IPTV” device capable of receiving broadcasts over the internet. Later, in step 404, user 104 turns off the entertainment device and turns on his mobile device. In step 406, the mobile device transmits updated information to server 102, which updates network contact list 208.

FIG. 5 shows a method for a user to send content to other users through the present invention. In step 502, user 100 decides to send streaming video to his family, users 104a, 104b, 104c, and 104d. User 100 does not know where his family members are or what devices they are presently operating. With the present invention, user 100 does not need to know this information; the present invention will figure it out for him. User 100 selects “send all” to his family group list, comprising users 104a, 104b, 104c, and 104d. The mobile device sends the streaming video, along with information identifying users 104a, 104b, 104c, and 104d.

Network server 102 receives the streaming video and identifying information in step 504. The network server 102 consults network contact list component 208 and retrieves information about users 104a, 104b, 104c, and 104d. In this case, network server 102 determines that user 104a is using a mobile device, user 104b is using a personal computer, user 104c is using an internet protocol enabled entertainment device, and user 104d is not available.

After network server 102 retrieves the information about users 104a, 104b, 104c, and 104d, in step 506, server 102 uses the information to determines the best method to transmit the video to the respective users. The best method may be a particular route through the network. The best method could also be the particular format for the content. Ultimately, the best method is the method that provides the greatest likelihood that each user 104a, 104b, 104c, 104d will receive the content properly. If necessary, server 102 translates the streaming video into a format compatible with the various devices being operated by users 104a, 104b, 104c, and 104d. This may require no translation for user 104a, since user 104a is also using a mobile device. Users 104b and 104c, however, will each receive different formats of the content suitable for a personal computer and an internet protocol enabled entertainment device, respectively.

Finally, in step 508, network server 102 transmits the video stream to users 104a, 104b, and 104c. Each user receives the respective formatted content formatted in step 504. In this fashion, users 104a, 104b, and 104c receive content from user 100 without user 100 having to figure out what devices users 104a, 104b, 104c, and 104d are presently operating or how to transmit the content to those users. This ease of use enhances user 100's network experience and reduces frustration; the process “just works” from the user's perspective.

In the example given above, user 104d is not available. In this case network server 102 may take a number of actions. Server 102 could notify user 100 that user 104d is not available and not transmit the streaming video to user 104d. Server 102 could also store a copy of the streaming video, either in a network server or on a users local storage device and transmit the video to user 104d (or notify user 104d of the video) when user 104d becomes available.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for delivering content to a plurality of users comprising a plurality of components stored in a computer-readable medium, the components comprising:
a network contact list component capable of storing a list of users and corresponding user information;
a reception component capable of receiving a transmission from a first device, the transmission comprising content and a set of users to whom the content should be delivered; and
a transmission component capable of transmitting said content to said user based on said user information stored in the contact list component.

2. The system of claim 1, wherein the plurality of components are stored in at least one of a network server and a mobile device.

3. The system of claim 1, wherein said user information comprises at least one of location information, presence information, device information, or availability information.

4. The system of claim 1, further comprising a content formatting component capable of obtaining said content and said set of users from said reception component, determining the current location and current device of each of said users in said set of users, and translating said content, for each user in said set of users, into a plurality of formatted content capable of being viewed by a particular viewer in said set of users; and wherein said transmission component transmits said formatted content to each user in said set of users for whom that formatted content was created.

5. The system of claim 1, wherein at least one of said users in said set of users is using a mobile device.

6. The system of claim 1, wherein at least one of said users in said set of users is using a personal computer or internet protocol enabled entertainment device.

7. The system of claim 1, wherein the transmission component transmits information to the first device based on user information stored in said network contact list component.

8. A system having a plurality of components stored in a computer readable medium, the components comprising:
a contact list component capable of storing a list of users and corresponding information about each user, said information comprising at least one of current location, current presence, current device, or current availability;
an update component capable of receiving updated information and updating said contact list component with said updated information;
an update transmission component capable of transmitting updated information to said update component.

9. The system of claim 8, wherein the contact list component and the update component are stored on at least one network server.

10. The system of claim 8, wherein the update transmission component is stored in a device owned by a user.

11. The system of claim 10, wherein the update transmission component transmits updated information when the user performs at least one of using a new device, moving to a new location, or changing availability status.

12. The system of claim 10, wherein the update transmission component transmits updated device and location automatically after a fixed interval.

13. The system of claim 10, wherein the device is a mobile device.

14. The system of claim 10, wherein the transmission component determines the optimal way to transmit said content to each of said plurality of users based on said corresponding information.

15. A method for transmitting content to a plurality of users, comprising the steps of:
a first user selecting content to distribute and a plurality of users to whom the content should be distributed;
determining, for each of said plurality of users, at least one of the user's current device, location, or availability;
converting, for each of said users, the content into a plurality of formatted content, each of which is capable of being viewed by one of the plurality of users based on at least one of said user's current device, location, presence, or availability; and
transmitting the particularly formatted content translated for each user in said plurality of users to said user.

16. The method of claim 15, wherein the determining, translating, and transmitting steps are performed by at least one network server.

17. The method of claim 16, further comprising the step of transmitting the content and the at least one of the user's current device, current location, current presence, or current availability from said first user's device to one of said at least one network servers.

18. The method of claim 15, wherein the determining step is performed by consulting a network contact list.

19. The method of claim 15, wherein the plurality of users use one or more of a mobile device, a personal computer, and an internet protocol enabled entertainment device.

20. The method of claim 15, wherein said first user uses one or more of a mobile device, a personal computer, and an internet protocol enabled entertainment device.
